(19) United States
(12) Patent Application Publication
(10) Pub. No.: US 2014/0278518 A1
(43) Pub. Date: Sep. 18, 2014

(54) MEDICAL APPARATUS ADMINISTRATION DEVICE AND MEDICAL APPARATUS ADMINISTRATION METHOD

(71) Applicant: TERUMO KABUSHIKI KAISHA, Tokyo (JP)

(72) Inventors: Koichiro Asama, Hadano-shi (JP); Hiroko Tounooka, Hadano-shi (JP)

(73) Assignee: TERUMO KABUSHIKI KAISHA, Tokyo (JP)

(21) Appl. No.: 14/221,960

(22) Filed: Mar. 21, 2014

Related U.S. Application Data
(63) Continuation of application No. PCT/JP2012/005987, filed on Sep. 20, 2012.

(30) Foreign Application Priority Data
Sep. 22, 2011 (JP) 2011-207730

(51) Int. Cl. G06F 19/00

(52) U.S. Cl. CPC G06F 19/3406
USPC 705/2

(57) ABSTRACT

A medical equipment management apparatus and a medical equipment management method are disclosed, which obtains information for suitably out responding to an alarm from a medical equipment and can perform CQI based on the information related to the timing in which the responding operation is performed is disclosed. The medical equipment management apparatus can obtain responding time information related to the time until a medical equipment, arranged in a different region, which has output abnormal information is reset to a normal state, with region information related to a region in which the medical equipment is arranged and responding operation timing information, produces region and responding timing related responding time information for displaying responding time information in relation to the region information and the responding operation timing information of the medical equipment, and display the region and responding timing related responding time information on a display of a personnel side terminal.

### CROSS REFERENCES TO RELATED APPLICATIONS

This application is a continuation of International Application No. PCT/JP2012/005987 filed on Sep. 20, 2012, and claims priority to Japanese Application No. 2011-207730 filed on Sep. 22, 2011, the entire content of both of which is incorporated herein by reference.

### TECHNICAL FIELD

The present invention generally relates to a medical equipment management apparatus and a medical equipment management method for managing medical equipment, for example, an infusion pump.

### BACKGROUND DISCUSSION

When liquid medicine is administered, for example, to a patient by drip infusion in hospitals, medical equipment such as an infusion pump can be used to correctly control a dose of medicine.

The infusion pump can include a transfusion tube and can be configured to cause a liquid medicine to flow inside the infusion tube. The infusion pump can be configured that when the infusion tube is clogged or is in a similar state, an alert (alarm) is output, for example, see JP 11-137676 A.

An assigned medical care worker such as a nurse can carry out an operation, in response to the alert (alarm), such as removing the clogging for resetting.

However, there are differences in the number of medical care workers, the experience of the medical care workers, for example, among areas such as an ICU (Intensive Care Unit), a General Ward, or the like, for example, in which medical equipment such as an infusion pump can be arranged. When the medical equipment such as an infusion pump or the like, for example, outputs an alert, the elapsed time before the medical equipment restarts, and responding to the alert, is not always constant, such that the quality of medical care may not be uniformly provided.

### SUMMARY

In accordance with an exemplary embodiment, a medical equipment management apparatus and a medical equipment management method is disclosed, which can obtain information for suitably responding to an alarm from a medical equipment and, which can perform CQI (Continuous Quality Improvement) based on the information.

In accordance with an exemplary embodiment, a medical equipment management apparatus is disclosed, which is configured to obtain the responding time information related to the time until a medical equipment, each arranged in a different region, which has output abnormal information is reset to a normal state, together with the region information related to a region in which the medical equipment is arranged and the responding operation timing information related to the timing in which the responding operation is performed, produce the region and responding timing related responding time information for displaying the responding time information in relation to the region information and the responding operation timing information of the medical equipment, and display the region and responding timing related responding time information on a display of the personnel side terminal.

According to the configuration, the region and responding timing related responding time information can be presented in relation to the region information and the responding operation timing information of the medical equipment.

Therefore, a personnel who visually recognizes the region and responding timing related responding time information, for example, such as a doctor or the like can immediately understand how the responding time information differs in relation to the region information, for example, an ICU (Intensive Care Unit) and an OPE (operating room) and the responding timing information, for example, during the morning. In addition, personnel can know, for example, suitable number of medical care workers such as a nurse to be arranged in the region such as the ICU (Intensive Care Unit), the OPE (operating room), or the like, thereby allowing to perform the CQI (Continuous Quality Improvement).

In accordance with an exemplary embodiment, the responding time information can be a time information related to the time until the medical equipment is reset to a normal state with the medicine of which type is the same as the medicine used by the medical equipment when the abnormal information has been output.

In accordance with an exemplary embodiment, since the responding time information is the time information until the medical equipment is reset to a normal state with the medicine of which type is the same as the medicine used by the medical equipment when the abnormal information has been output, the time information related to a case when the medical equipment is reset to a normal state with the medicine changed after the abnormal information has been output can be eliminated.

Therefore, correct responding time information related to the time until being reset to a normal state can be obtained.

In accordance with an exemplary embodiment, standard labor cost information of a performer who has performed the responding operation can be included, and the responding time labor cost information which is a labor cost of the performer who has performed the responding operation is obtained based on the responding time information and the standard labor cost information, and that the responding time labor cost information is displayed together with the region and responding timing related responding time information.

According to the configuration, since the responding time labor cost information is displayed together with the region and responding timing related responding time information, a personnel such as a doctor who visually recognizes the information can immediately study the suitable number of medical care worker such as a nurse to be arranged in a region such as the ICU (Intensive Care Unit), the OPE (operating room), or the like also from a view point of cost.

In accordance with an exemplary embodiment, objective assessment information of the performer who has performed the responding operation can be produced based on the responding time information, and the objective assessment information is displayed together with the region and responding timing related responding time information.

According to the configuration, the objective assessment information can be displayed together with the region and responding timing related responding time information, a personnel such as a doctor who visually recognizes the information can obtain objective assessment information regarding a suitable number of medical care workers such as nurses to be arranged in a region such as the ICU (Intensive Care Unit), the OPE (operating room), or the like.

In accordance with an exemplary embodiment, the objective assessment information can be assessment information of a responding time length of the performer who has performed the responding operation.

According to the configuration, since the objective assessment information is an assessment information of the responding time length of the performer who has performed the responding operation, a personnel such as a doctor who visually recognizes the information can easily understand that the situation such as a lack of the number of workers exists.

In accordance with an exemplary embodiment, the objective assessment information is the information of degree of distribution of a plurality of pieces of responding time information included in the responding time information.

According to the configuration, since the objective assessment information is the information of degree of distribution of the plurality of pieces of responding time information included in the responding time information, there can be differences in skill for each performer who has performed the responding operation. In addition, it can easily be understood that training is not thoroughly done.

In accordance with an exemplary embodiment, the objective assessment information is the information of disparity among the pieces of responding time information of the different pieces of responding operation timing information.

According to the configuration, since the objective assessment information is the information of disparity among the pieces of responding time information of the different pieces of responding operation timing information, a mismatch of arrangement of workers in the area for a time zone can rather easily be understood.

In accordance with an exemplary embodiment, a medical equipment management method is disclosed, which is configured to obtain the responding time information related to the time until a medical equipment, each arranged in a different region, which has output abnormal information is reset to a normal state, together with the region information related to a region in which the medical equipment is arranged and the responding operation timing information related to the timing in which the responding operation is performed, produce the region and responding timing related responding time information for displaying the responding time information in relation to the region information and the responding operation timing information of the medical equipment, and display the region and responding timing related responding time information on a display of the personnel side terminal.

In accordance with an exemplary embodiment, a medical equipment management apparatus is disclosed, the medical equipment management apparatus configured to: obtain responding time information related to a time until a medical equipment, arranged in a different region, which has output abnormal information is reset to a normal state, together with region information related to a region in which the medical equipment is arranged and responding operation timing information related to a timing in which a responding operation is performed; produce region and responding timing related responding time information for displaying the responding time information in relation to the region information and the responding operation timing information of the medical equipment, and display the region and responding timing related responding time information on a display of a personnel side terminal.

In accordance with an exemplary embodiment, a medical equipment management method is disclosed, the medical equipment management method comprising: obtaining responding time information related to a time until a medical equipment, arranged in a different region, which has output abnormal information is reset to a normal state, together with region information related to a region in which the medical equipment is arranged and responding operation timing information related to the timing in which the responding operation is performed; producing region and responding timing related responding time information for displaying the responding time information in relation to the region information and the responding operation timing information of the medical equipment, and displaying the region and responding timing related responding time information on a display of a personnel side terminal.

### BRIEF DESCRIPTION OF DRAWINGS

FIG. 1 is a schematic view illustrating a pump CQI system according to an exemplary embodiment including a medical equipment management apparatus of the present disclosure such as a management server.

FIG. 2 is a schematic block diagram illustrating an exemplary main configuration of the infusion pump in FIG. 1.

FIG. 3 is a schematic view illustrating an exemplary main configuration of the management server in FIG. 1.

FIG. 4 is a schematic block diagram illustrating a content of each memorizing unit in FIG. 3.

FIG. 5 is a schematic flow chart illustrating a main operation or the like of the CQI system according to an exemplary embodiment.

FIG. 6 is a schematic flow chart illustrating a main operation of the CQI system according to an exemplary embodiment.

FIG. 7 is a schematic explanatory drawing illustrating an example of “time and area related responding time data” in FIG. 2.

FIG. 8 is a schematic explanatory drawing illustrating an example of “average responding time and standard deviation data for each area and time zone”.

FIG. 9 is a schematic explanatory drawing illustrating a chart of “alert responding time analysis data”.

FIG. 10 is a schematic explanatory drawing illustrating an exemplary data displayed on a terminal side display of a medical office terminal.

### DETAILED DESCRIPTION

Since the exemplary embodiments described below are examples of a medical equipment management apparatus and method disclosed here, aspects are described. However, the scope of the present invention is not limited to these aspects, absent a description to the contrary.

A medical equipment management apparatus and a medical equipment management method which can obtain information for suitably carrying out an operation responding to an alarm from the medical equipment, and can perform the CQI (Continuous Quality Improvement) based on the information is disclosed.

As illustrated in FIG. 1, a pump CQI (Continuous Quality Improvement) system 1 includes infusion pumps 2a to 2e or the like, for example arranged in a region (area) such as an ICU (Intensive Care Unit), an OPE (operating room), a CCU (Coronary Care Unit), a Clinic (outpatient care), a General ward, or the like.

The infusion pump 2a or the like, for example, can be medical equipment, which can be used together with an equipment such as a drip infusion for correctly administering medicines to a patient.

For example, even though the exemplary embodiment is described using the infusion pump 2a or the like, the medical equipment according to the present disclosure may be, for example, a syringe pump or the like.

As illustrated in FIG. 1, the infusion pump 2a is communicatably connected to a management server 10, and also communicatably connected to, for example, medical office terminals 3a to 3c, which can be personnel side terminals arranged in the medical office or the like for a doctor or the like.

In the medical office terminal 3a or the like, for example, terminal side displays 4a to 4c, each being a display, for example, can be formed.

In the exemplary embodiment, for convenience of description, an example in which the infusion pump 2a can be directly connected to the management server 10 as illustrated in FIG. 1 is described. However, the present disclosure is not limited to such configuration and may have a configuration in which each infusion pump 2a or the like, for example, is connected to the management server via a “pump communication software (gateway terminal)” which manages the infusion pump 2a or the like. In this case, the “pump communication software (gateway terminal)” and the “management server” can share the function of the management server 10 of the embodiment.

The pump CQI system 1 according to an exemplary embodiment is a system for putting forward continuous medical quality improvement related to the infusion pump 2a. When abnormal information, for example, an alert (alarm) from the infusion pump 2a is output from an operation history (pump history) collected from the infusion pump 2a, the pump CQI system 1 analyzes a responding time consumed during a resetting operation for setting the operation to a normal state, so as to perform improvement in, for example, arrangement of the suitable number of a medical care worker such as a nurse who is to be arranged in the ICU (Intensive Care Unit), the OPE (operating room), or the like in which the infusion pump 2a is set.

The infusion pump 2a, the management server 10, and the medical office terminal 3a, for example, illustrated in FIG. 1 can include a computer. The computer includes a CPU (Central Processing Unit), a RAM (Random Access Memory), a ROM (Read Only Memory), not shown in the drawing, which can be connected via a bus.

As illustrated in FIG. 2, the infusion pump 2a can include a pump control unit 120 and performs an operation of administering liquid medicine by drip infusion or the like, for example, to a patient at a predetermined administration rate. The infusion pump 2a can also include a pump main body 121 which performs function of stopping the operation of the infusion pump 2a when an abnormal state such as clogging in a transfusion tube of the infusion pump 2a occurs, and a clogging detection equipment 122 having a sensor or the like which can detect clogging when such happens in the infusion pump 2a, for example, during administration of liquid medicine.

Further, the infusion pump 2a can include an alert (alarm) equipment 123 which can detect an abnormal state when the clogging detection equipment 122 detects a clogging in the infusion pump 2a, a clock equipment 124 which is a clock, an infusion pump side communication equipment 125 which can allow the infusion pump 2a to communicate with the management server 10, and an infusion pump side input equipment 126 for inputting each type of signal or the like to the infusion pump 2a.

The pump main body 121 can be connected to the pump control unit 120, for example, as illustrated in FIG. 2 and can be controlled.

The pump control unit 120 can also control each type of memorizing unit and each type of processing unit (program) as illustrated in FIG. 2, and these configurations will be described below.

As illustrated in FIG. 3, the management server 10 can include a management server control unit 11, a display for displaying each type of data, for example, a management server side display 12, a management server side input equipment 13 for inputting each type of data, and a management server side communication equipment 14 which allows the management server 10 to communicates with the infusion pump 2a or the medical office terminal 3a, for example.

These management server side display 12 and the like, for example can be connected to the management server control unit 11 and controlled. Further, as illustrated in FIG. 3, the management server control unit 11 has a configuration, which can also control each type of memorizing unit 40 and each type of processing unit (program). The content of each type of memorizing unit 40 and each type of processing unit (program) will be described below. FIG. 4 is a schematic block diagram illustrating a content of each memorizing unit 40 in FIG. 3 of which content will be described below.

FIGS. 5 and 6 are schematic flow charts illustrating main operations or the like of the CQI system 1 according to the embodiment. An embodiment will be described along with flow charts in FIG. 5 and FIG. 6, and configurations in FIGS. 1 to 4 will be described below.

First, in step (hereinafter referred to as “ST”) 1 in FIG. 5, the power switch of the infusion pump 2a in FIG. 1 is “ON”, and when a medicine, for example, “Diprivan (a trademark of AstraZeneca K.K.)” which is an anesthetic is set in the infusion pump 2a, the infusion pump 2a makes the data of the medicine name “Diprivan” to be memorized in a “first medicine name data memorizing unit 127” in FIG. 2.

Then, the step proceeds to ST2. In ST2, the liquid supply stopping operations detection processing unit (program) 128 in FIG. 2 operates to decide whether a “liquid supply stopping operation” and an “alert” have been output. For example, when a clogging or the like occurs in a transfusion tube of the infusion pump 2a so that the clogging detection equipment 122 can detect the clogging and an alert (alarm) equipment 123 can output an alert, the pump main body 121 can simultaneously stop operation of liquid supply of the liquid medicine “Diprivan”.

When it is decided in ST2 that the infusion pump 2a has output an alert and simultaneously has carried out a stopping operation of liquid supply of the liquid medicine “Diprivan”, the step proceeds to ST3.

In ST3, the infusion pump 2a obtains the liquid supply stopping time from the clock equipment 124 in FIG. 2 and makes the liquid supply stopping time data to be memorized in a the liquid supply stopping time data memorizing unit 129.

Then the step proceeds to ST4. In ST4, whether the liquid supply restart command has been input to the infusion pump 2a or the like is decided.

Specifically, for example, when an alert is output from the infusion pump 2a or the like arranged in the ICU (Intensive Care Unit) and, thereby, the liquid supply operation stops, a medical care worker such as a nurse or the like arranged in the ICU checks the infusion pump 2a and carries out processing such as refilling with a new liquid medicine “Diprivan” so as to restart (reset) the liquid supply operation of the infusion pump 2a in a normal state.

Then, in ST4, the liquid supply restart command input signal detection processing unit (program) 130 in FIG. 2 decides whether such liquid supply restart command has been input to the infusion pump 2a.

In ST4, when the liquid supply restart command is input, the step proceeds to ST5. In ST5, it is decided whether the medicine name related to the restart of liquid supply is identical to (one of those of the same type of) the first medicine name. Specifically, a “liquid supply restart related “medicine name” comparison processing unit (program) 131” in FIG. 2 operates, in the embodiment, for example, to decide whether the medicine name is the same name as “Diprivan”.

As described above, the embodiment is configured so that the case when liquid supply is restarted with a different medicine being set is not taken into account, but only the case when liquid supply restarts with the same medicine is taken into account. Thereby, only the case when correct response to the alert is performed is taken into account so that reliability of the data of “responding time” which will be described below is improved.

In ST5, when it is decided that the medicine name related to the restart of liquid supply is identical to the first medicine name, the step proceeds to ST6.

In ST6, a “time and area related responding time data production processing unit (program) 132” in FIG. 2 operates to obtain “liquid supply restart time data” with reference to the clock equipment 124.

Then, the time between the “liquid supply restart time data” and the “liquid supply stopping time data” in the “liquid supply stopping time data memorizing unit 129” in FIG. 2 is made to be memorized in a “time and area related responding time data memorizing unit 133” in FIG. 2 as a “responding time”, and the “liquid supply restart time data” is made to be memorized in the “time and area related responding time data memorizing unit 133” in FIG. 2 as “time and area related responding time data 133a” with relation to “current date (e.g., Jan. 15, 2010) and time data (e.g., 8:00 to 8:30)” and “area (e.g., ICU)”.

As illustrated in FIG. 7, the time data is memorized as “Jan. 15, 2010, 8:00 to 8:30”, the area as “ICU”, and the responding time as “30 minutes”.

As described above, the “time data” is an example of the responding operation timing information, the “ICU” is an example of the region information, and the “responding time” is an example of the responding time information.

In this manner, the infusion pump 2a or the like obtains data of the responding time of a medical care worker such as a nurse or the like in the area (for example, ICU) related to the time from the “liquid supply stop” and the “alert output” to the following “liquid supply restart (reset)”.

Then, the step proceeds to ST7. In ST7, the infusion pump 2a can transmit the “time and area related responding time data 133a” illustrated in FIG. 7 to the management server 10 in FIG. 1 via an infusion pump side communication equipment 125 in FIG. 2.

Then, the step proceeds to ST8. In ST8, the management server 10 makes the “time and area related responding time data 133a” received from the infusion pump 2a to be memorized in a “management server side time and area related responding time data memorizing unit 41” in FIG. 4.

Then, the step proceeds to ST9. In ST9, an “average responding time and standard deviation data for each area and time zone production processing unit (program) 15” in FIG. 3 operates to produce “average responding time and standard deviation data for each area and time zone 42a” based on “management server side time and area related responding time data” in the “management server side time and area related responding time data memorizing unit 41” in FIG. 4 and to make the “average responding time and standard deviation data for each area and time zone 42a” to be memorized in an “average responding time and standard deviation data for each area and time zone memorizing unit 42”.

As illustrated in FIG. 8, the data 42a includes the average responding time and standard deviation for each area (e.g., ICU) and time zone (e.g., 0:00 to 6:00). That is, the “average responding time and standard deviation data for each area and time zone 42a” is produced by processing based on the “time and area related responding time data 133a” in FIG. 7.

Then, the step proceeds to ST10. In ST10, a “worker cost production processing unit (program) 16” in FIG. 3 operates to produce “worker cost data” for each area based on the number of pieces of data (that is, the number of alerts) of “time and area related responding time data 133a” in FIG. 7 in the “management server side time and area related responding time data memorizing unit 41” in FIG. 4, “average responding time data” in “average responding time and standard deviation data for each area and time zone 42a” in FIG. 8 in the “management server side time and area related responding time data memorizing unit 41” in FIG. 4, the number of workers in the area in a “worker data for each area memorizing unit 43 (for example, data of workers arranged in an area such as ICU, or the like)” in FIG. 4, and hourly wage standard data of a medical care worker such as a nurse in an “hourly wage standard data memorizing unit 44” in FIG. 4, and to make the “worker cost data” for each area to be memorized in a “worker cost data memorizing unit 45” in FIG. 4.

The data shows how much labor cost is required, by the “responding time” to reset the infusion pump 2a or the like of a medical care worker such as a nurse or the like, for example, from the data of a worker, an average responding time, an hourly wage, or the like for each area such as an ICU. Therefore, a doctor or the like who visually recognizes the data can rapidly and suitably make assessment whether the arrangement of a worker for each area or the like is appropriate from a viewpoint of cost.

The “worker cost data” is an example of the responding time labor cost information and the “hourly wage standard data” is an example of the standard labor cost information.

Then, the step proceeds to ST11. In ST11, an “alert responding time analysis data production processing unit (program) 17” in FIG. 3 operates to produce “alert responding time analysis data 46a” based on the “average responding time and standard deviation data for each area and time zone 42a” in FIG. 8, and to make the “alert responding time analysis data 46a” to be memorized in an “alert responding time analysis data memorizing unit 46” in FIG. 4.

As illustrated in FIG. 9, the “alert responding time analysis data 46a” (chart) shows an average responding time and standard deviation in each area (an ICU (Intensive Care Unit), an OPE (operating room), a CCU (Coronary Care Unit), a Clinic (outpatient care), and a General Ward) for each of the four time zones (0:00 to 6:00, 6:00 to 12:00, 12:00 to 18:00, and 18:00 to 24:00).

The “alert responding time analysis data 46a” is an example of the region and responding timing related responding time information.

Therefore, a doctor or the like who visually recognizes the “alert responding time analysis data 46a” can understand the situation of the “responding time” for each time zone and each area so that the “alert responding time analysis data 46a” can be used as a material for studying optimum arrangement of a worker for each time zone and each area. Thereby, the CQI (Continuous Quality Improvement) can be performed.

Then, the step proceeds to ST12. In ST12, a responding time length assessment processing unit (program) 18 operates to compare the “average responding time” in the “average responding time and standard deviation data for each area and time zone 42a” in FIG. 8 and the “standard average responding time data” which is the average responding time data, memorized in a “standard average responding time data memorizing unit 47” in FIG. 4, used as an objective standard, decide whether the average responding time is longer or shorter than the standard, produce the responding time length assessment data, and make the responding time length assessment data to be memorized in a “responding time length assessment data memorizing unit 48” in FIG. 4.

By comparing the “average responding time data” for each area and time zone with the “standard average responding time data”, a decision can be made whether the average responding time data is longer or shorter than the standard value. A doctor or the like who recognizes that the “average responding time data” is longer than the standard by visually recognizing the “responding time length assessment data” can immediately understand the lack of workers in the area or time zone.

In accordance with an exemplary embodiment, the “responding time length assessment data” is an example of the assessment information of the responding time length (objective assessment information).

Then, the step proceeds to ST13. In ST13, a responding time dispersion assessment processing unit (program) 19 operates to process difference data among each pieces of “responding time data” in the management server side time and area related responding time data memorizing unit 41 in FIG. 4, compare with the “dispersion standard data” in a “dispersion standard data memorizing unit 49” in FIG. 4, decide whether the dispersion is large, produce dispersion assessment data of the dispersion, and make the dispersion assessment data to be memorized in a “dispersion assessment data memorizing unit 50” in FIG. 4.

By visually recognizing the “dispersion assessment data” of the “responding time”, a doctor or the like can immediately understand the fact such that there is great difference among medical care workers such as a nurse for each time zone and each area, and also understand that training of the medical care worker is not thoroughly done.

In accordance with an exemplary embodiment, the “dispersion assessment data” is an example of the information of degree of distribution of a plurality of pieces of responding time information.

Then, the step proceeds to ST14. In ST14, a “responding time difference for each time zone assessment processing unit (program) 20” in FIG. 3 operates to compare the difference data in the “average responding time data” for each time zone in the “average responding time and standard deviation data for each area and time zone 42a” in FIG. 8 and “time zone difference standard data” in a “time zone difference standard data memorizing unit 51” in FIG. 4, decide whether the difference data is larger than the “time zone difference standard data”, that is, whether the difference among time zones is large, produce “responding time difference for each time zone assessment data”, and make the “responding time difference for each time zone assessment data” to be memorized in a “responding time difference for each time zone assessment data memorizing unit 52” in FIG. 4.

When the difference data of the “average responding time data” for each time zone for each area is large, a doctor or the like who visually recognizes such data can immediately understand that there is a mismatch in arrangement of a worker for each time zone, and can make an improvement plan.

The “responding time difference for each time zone assessment data” is an example of the information of disparity among the pieces of the responding time information.

Then, the step proceeds to ST15. In ST15, the management server 10 displays the “alert responding time analysis data 46a” in FIG. 9, the “worker cost data” in FIG. 4, for example, on the terminal side display 4a or the like of the medical office terminal 3a, in FIG. 1, for example.

As illustrated in FIG. 10, the “alert responding time analysis data 46a” and the “worker cost data” can be displayed on the terminal side display 4a, for example.

Although not illustrated in FIG. 10, the “responding time length assessment data”, the “dispersion assessment data”, and the “responding time difference for each time zone assessment data” in FIG. 4 can simultaneously be displayed.

In this case, a doctor or the like who sees the terminal side display 4a, for example, can immediately understand, for example, what is to be improved for arrangement of a worker for each area, each time zone, or the like based on the “responding time” to the alert, as described above. Therefore, CQI (Continuous Quality Improvement) can be performed.

The detailed description above describes a medical equipment management apparatus and medical equipment management method disclosed by way of example. The invention is not limited, however, to the precise embodiment and variations described. Various changes, modifications and equivalents can be effected by one skilled in the art without departing from the spirit and scope of the invention as defined in the accompanying claims. It is expressly intended that all such changes, modifications and equivalents which fall within the scope of the claims are embraced by the claims.

What is claimed is:

1. A medical equipment management apparatus, the medical equipment management apparatus configured to:
obtain responding time information related to a time until a medical equipment, arranged in a different region, which has output abnormal information is reset to a normal state, together with region information related to a region in which the medical equipment is arranged and responding operation timing information related to a timing in which a responding operation is performed;
produce region and responding timing related responding time information for displaying the responding time information in relation to the region information and the responding operation timing information of the medical equipment, and
display the region and responding timing related responding time information on a display of a personnel side terminal.

2. The medical equipment management apparatus according to claim 1, wherein the responding time information is time information related to the time until the medical equipment is reset to the normal state with a medicine of which type is a same type as the medicine used by the medical equipment when the abnormal information was output.

3. The medical equipment management apparatus according to claim 1, further includes standard labor cost information of a performer who has performed the responding operation, and wherein responding time labor cost information which is a labor cost of a performer who has performed the responding operation based on the responding time information and the standard labor cost information is obtained, and the responding time labor cost information is displayed together with the region and responding timing related responding time information.

4. The medical equipment management apparatus according to claim 2 further includes standard labor cost information of a performer who has performed the responding operation, and wherein responding time labor cost information which is a labor cost of a performer who has performed the responding operation based on the responding time information and the standard labor cost information is obtained, and the responding time labor cost information is displayed together with the region and responding timing related responding time information.

5. The medical equipment management apparatus according to claim 1, wherein objective assessment information of a performer who has performed the responding operation is produced based on the responding time information, and the objective assessment information is displayed together with the region and responding timing related responding time information.

6. The medical equipment management apparatus according to claim 2, wherein objective assessment information of the performer who has performed the responding operation is produced based on the responding time information, and the objective assessment information is displayed together with the region and responding timing related responding time information.

7. The medical equipment management apparatus according to claim 3, wherein objective assessment information of the performer who has performed the responding operation is produced based on the responding time information, and the objective assessment information is displayed together with the region and responding timing related responding time information.

8. The medical equipment management apparatus according to claim 4, wherein objective assessment information of the performer who has performed the responding operation is produced based on the responding time information, and the objective assessment information is displayed together with the region and responding timing related responding time information.

9. The medical equipment management apparatus according to claim 5, wherein the objective assessment information is assessment information of a responding time length of the performer who has performed the responding operation.

10. The medical equipment management apparatus according to claim 5, wherein the objective assessment information is information of degree of distribution of a plurality of pieces of responding time information included in the responding time information.

11. The medical equipment management apparatus according to claim 5, wherein the objective assessment information is information of disparity among the pieces of responding time information of the different pieces of responding operation timing information.

12. The medical equipment management apparatus according to claim 1, comprising:
a display configured to display the region and responding timing related responding time information.

13. A medical equipment management method, the medical equipment management method comprising:
obtaining responding time information related to a time until a medical equipment, arranged in a different region, which has output abnormal information is reset to a normal state, together with region information related to a region in which the medical equipment is arranged and responding operation timing information related to the timing in which the responding operation is performed;
producing region and responding timing related responding time information for displaying the responding time information in relation to the region information and the responding operation timing information of the medical equipment, and
displaying the region and responding timing related responding time information on a display of a personnel side terminal.

14. The medical equipment management method according to claim 13, wherein the responding time information is time information related to the time until the medical equipment is reset to the normal state with a medicine of which type is a same type as the medicine used by the medical equipment when the abnormal information was output.

15. The medical equipment management method according to claim 13, comprising:
obtaining standard labor cost information of a performer who has performed the responding operation;
obtaining responding time labor cost information which is a labor cost of a performer who has performed the responding operation based on the responding time information and the standard labor cost information; and
displaying the responding time labor cost information together with the region and responding timing related responding time information.

16. The medical equipment management method according to claim 13, comprising:
producing objective assessment information of a performer who has performed the responding operation based on the responding time information; and
displaying the objective assessment information together with the region and responding timing related responding time information.

17. The medical equipment management method according to claim 16, wherein the objective assessment information is assessment information of a responding time length of the performer who has performed the responding operation.

18. The medical equipment management method according to claim 16, wherein the objective assessment information is information of degree of distribution of a plurality of pieces of responding time information included in the responding time information.

19. The medical equipment management method according to claim 16, wherein the objective assessment information is information of disparity among the pieces of responding time information of the different pieces of responding operation timing information.
